(19) United States
(12) Patent Application Publication
(10) Pub. No.: US 2012/0189230 A1
(43) Pub. Date: Jul. 26, 2012

(54) Refuse Container Holder

(76) Inventor: Carol J. King, Norman, OK (US)

(21) Appl. No.: 13/010,941

(22) Filed: Jan. 21, 2011

(51) Int. Cl. B65D 33/00; F16B 2/06

(52) U.S. Cl. 383/33; 248/95

(57) ABSTRACT

A refuse container holder for selective attachment to a cabinet includes a base support member having back, side, and front walls that define an interior area. The container holder also includes a clamp rotatably coupled to the support member and configured to removably couple the support member to the countertop. The container holder includes a closure member having a configuration that is complementary to a configuration of the base support member so as to be selectively inserted into the base support member interior area. A refuse bag having an open end is selectively sandwiched between the base support member and the closure member when the closure member is inserted into the base support member interior area.

### BACKGROUND OF THE INVENTION

This invention relates generally to refuse containers and, more particularly to a refuse bag holder for selective attachment to a kitchen cabinet so that food scraps and other garbage may be brushed directly into a trash container.

Working in the kitchen, especially during food preparation, generates a large quantity of refuse such as food scraps, crumbs, packaging, paper towels, and the like. Traditionally, all of this garbage has to be picked up and deposited in a trash container or the trash container moved closer to the counter so that the refuse may be slid therein. Unfortunately, portions of the refuse winds up on the floor using either of the two methods of disposal discussed above.

Various devices have been proposed in the art for attaching a trash bag holder to a cabinet. Although assumably effective for their intended purposes, the existing devices and patent proposals are either mechanically complicated or do not provide secure options for mounting the device to various parts of the cabinet.

Therefore, it would be desirable to have a refuse container holder that is selectively attachable to a cabinet, such as to its countertop or to a drawer. Further, it would be desirable to have a refuse container holder that secures a refuse container between a base support member and a closure member such that attachment and removal of the trash container is easy and fast. In addition, it would be desirable to have a refuse container holder which may be mounted to either a cabinet countertop or drawer at a user's discretion.

### SUMMARY OF THE INVENTION

A refuse container holder for selective attachment to a countertop according to the present invention includes a base support member having back, side, and front walls that define an interior area. The container holder also includes a clamp rotatably coupled to the support member and configured to removably couple the support member to the countertop. The container holder includes a closure member having a configuration that is complementary to a configuration of the base support member so as to be selectively inserted into the base support member interior area. A refuse bag having an open end is selectively sandwiched between the base support member and the closure member when the closure member is inserted into the base support member interior area.

Therefore, a general object of this invention is to provide a refuse container holder that is attachable to a countertop or other counter component, such as a drawer, so that a trash bag may be held in immediate proximity to the location of trash such as food remnants, packaging, crumbs, or other refuse.

Another object of this invention is to provide a refuse container holder, as aforesaid, that is attachable flush with a countertop such that refuse may be slidably guided into a trash bag held thereby.

Still another object of this invention is to provide a refuse container holder, as aforesaid, that may selectively be attached to or removed from a counter with ease.

Yet another object of this invention is to provide a refuse container holder, as aforesaid, that allows a refuse container to be securely attached to and removed from a base support member.

A further object of this invention is to provide a refuse container holder, as aforesaid, that is configured to rest against or adjacent to the front of a counter during use so that refuse may be slid directly off of the counter and into a trash bag suspended in the container holder.

A still further object of this invention is to provide a refuse container holder, as aforesaid, that is easy to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a refuse container holder according to a preferred embodiment of the present invention illustrated in use coupled to a countertop;

FIG. 2 is a perspective view of the refuse container holder as in FIG. 1 coupled to a drawer of a counter;

FIG. 3a is a top view of the refuse container holder as in FIG. 1 removed from the countertop;

FIG. 3b is a front view of the refuse container holder as in FIG. 3a;

FIG. 3c is a side view of the refuse container holder as in FIG. 3b;

FIG. 4 is a perspective view of the refuse container holder as in FIG. 1 removed from the countertop; and

FIG. 5 is an exploded view of the refuse container as in FIG. 4.

### DESCRIPTION OF THE PREFERRED EMBODIMENT

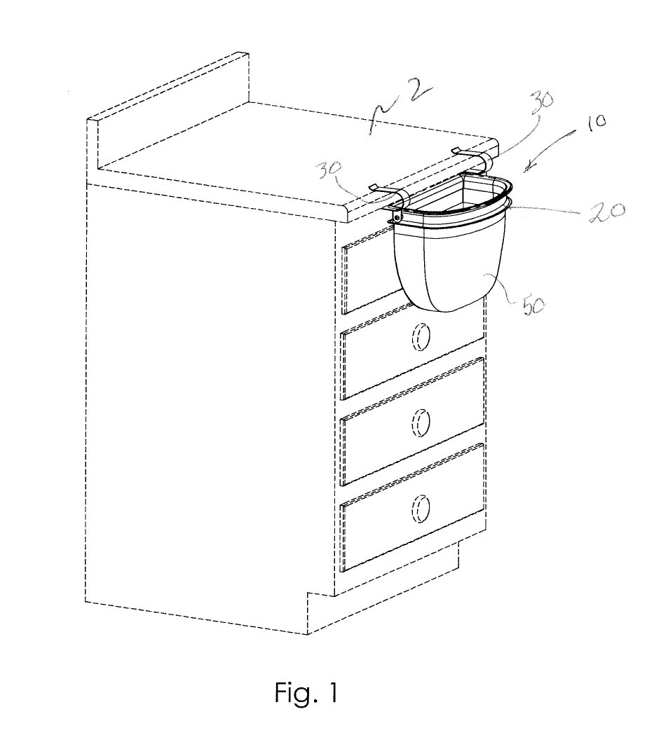

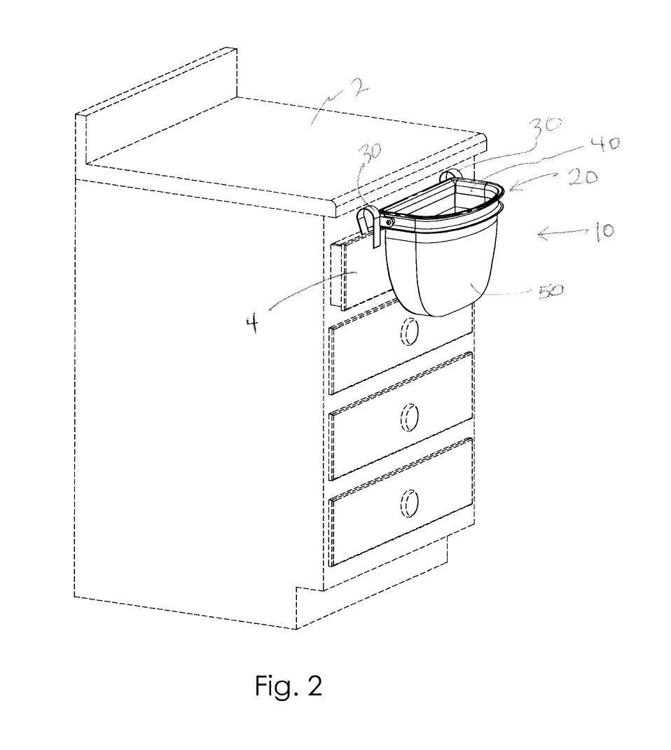

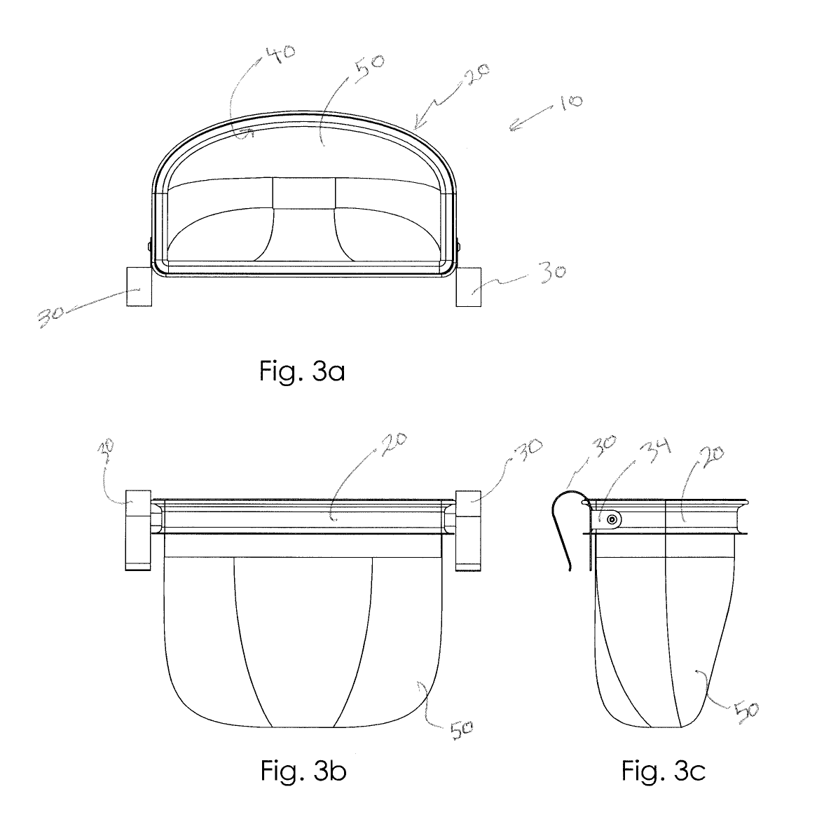

A refuse bag container holder according to a preferred embodiment of the present invention will now be described with reference to FIGS. 1 to 5 of the accompanying drawings. The container holder 10 includes a base support member 20, closure member 40, and at least one clamp 30 configured to selectively couple the container holder 10 to a cabinet.

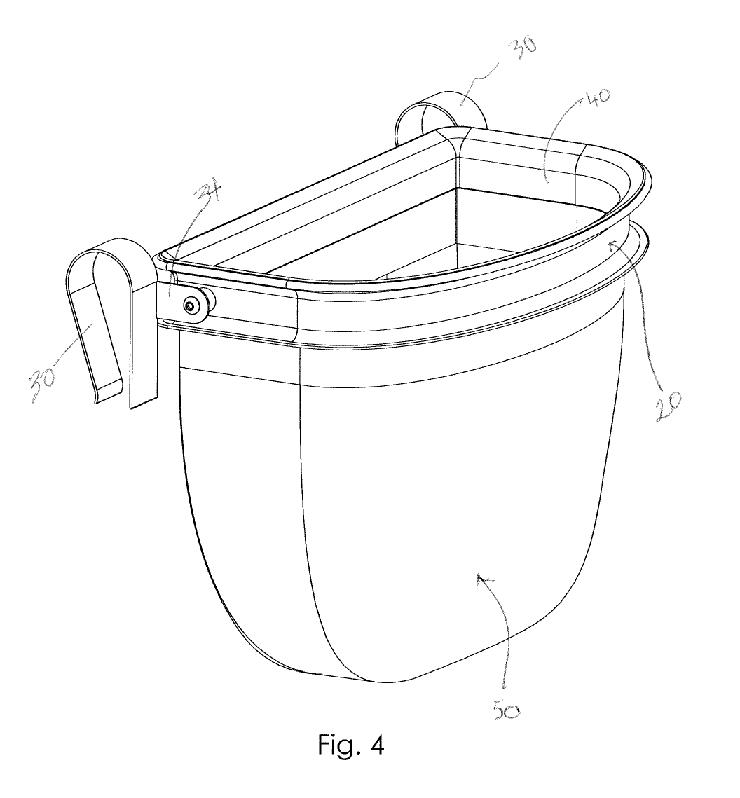

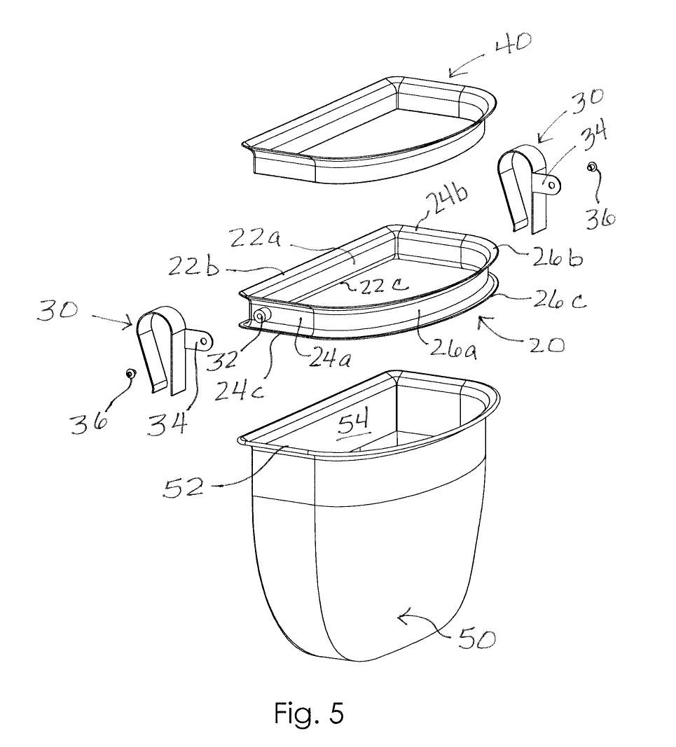

The base support member 20 includes a back wall 22a, opposed side walls 24a extending away from the back wall 22a and a front wall 26a connecting respective ends of the side walls 24a. The base support member 20 preferably includes a D-shaped configuration (FIGS. 4-5) although rectangular, oval, circular, or irregular configurations may also work. More particularly, the back wall 22a has a generally linear configuration such that it may rest against or immediately adjacent a cabinet front wall, as will be further described later. The side walls 24a are preferably parallel one to another and extend forwardly from opposed ends of the back wall 22a. The front wall 26a includes a generally forwardly annular configuration. Together, the walls define a perimeter and an open interior area 28. Each respective wall includes an upper edge 22b, 24b, 26b tapered outwardly. Each respective wall may also include an outwardly tapered lower edge 22c, 24c, 26c.

At least one clamp 30 is rotatably coupled to at least one of the side walls 24a of the base support member 20 (FIG. 5). Preferably, one clamp 30 is coupled to each side wall 24a so that the base support member 20 may be securely balanced when selectively attached to a countertop 2 or drawer 4. A mounting fastener 32, such as an interiorly threaded tube or flange, may be fixedly mounted to each side wall 24a and extend outwardly, a respective clamp 30 having a mounting arm 34 coupled to a respective mounting fastener 32 for rotation thereabout. A closure fastener 36, such as a threaded screw, may be inserted into the mounting fastener 32 when the mounting arm 34 is sandwiched therebetween to tighten the clamp 30 at a desired configuration. It should be appreciated that converse mounting means may be used; in other words, the mounting fastener may be exteriorly threaded, such as a bolt, and the closure fastener may be a nut, wing nut, or the like. A closure fastener 36 may be loosened by a user to enable a respective clamp to be rotated to a next desired configuration, such as a vertical configuration for drawer mounting, and then tightened again to secure the clamp 30 at the repositioned configuration.

The closure member 40 includes a configuration complementary to that of the base support member 20, such as a D-shaped configuration. The dimensions of the closure member 40, however, are slightly smaller than those of the base support member 20 such that the closure member 40 may selectively nest in the interior area 28 of the base support member 20 in a friction fit arrangement or be removed therefrom. Each wall of the closure member 40 includes an upper edge that is tapered outwardly such that the overall configuration of the closure member 40 is complementary to that of the base support member 20. Preferably, the base support member 20 and closure member 40 include a stainless steel construction although durable plastic or other materials may also be suitable.

The refuse container bag holder 10 further includes a plurality of refuse bags 50, which are used one of at a time with the device. Preferably, each bag 50 includes an open top 52 having a configuration that is complementary and substantially similar to that of the base support member 20 and closure member 40 (FIG. 5). In other words, a bag preferably includes a back portion 54 having a planar configuration so that the area adjacent the open top 52 thereof may be positioned between the base support member and respective walls of the closure member 40. The open top 52 of the bag 50 may also include an outwardly tapered portion complementary to similar structures of the base support member 20 and closure member 40. The closure member 40 holds the bag 50 securely in place when it is sandwiched in the interior area 28 of the base support member 20 and the closure member 40 is nested. Although a bag 50 having a D-shaped configuration is preferred, bags having other configurations would also be suitable.

In use, an empty refuse bag 50 may be positioned with the edge of its open top 52 adjacent the walls of the base support member 20 and the closure member 40 is then nested within the interior area 28 of the base support member 20. In so doing, the refuse container holder 10 tightly secures a bag 50 for use in collecting trash. The clamps 30 mounted to the side walls 24a of the refuse container holder 10 may be positioned substantially horizontally in the manner discussed above for attaching the device to a countertop 2 or substantially vertically—with the open end of the clamps 30 situated downwardly for attaching the device to a cabinet drawer 4, as desired. In either case, the clamps 30 may be tightened to resist rotational movement once a desired configuration is selected. Refuse such as food particles, disposable food packaging, disposable utensils, or the like may be brushed across a countertop and right into the bag 50. The outwardly tapered edges of the base support member 20 and closure member 40 effectively funnel trash into the bag 50 straight from the countertop without first picking it up and transporting it to the bag 50. The bag 50 may then be easily removed and replaced as needed by separating the closure member 40 from the base support member 20 and withdrawing the bag 50. A new bag 50 may then be inserted as described above.

In another embodiment (not shown), a support rod may be coupled to the front wall and be configured to extend rearwardly so as to bear against a front of the cabinet to which the support holder 10 is coupled. The support rod, therefore, provides enhanced support for a refuse laden container bag so that the support member 20 does not bend or break. This embodiment may be especially useful in a commercial kitchen environment or in residential applications in which bags having relatively larger volumes are used.

It is understood that while certain forms of this invention have been illustrated and described, it is not limited thereto except insofar as such limitations are included in the following claims and allowable functional equivalents thereof.

1. A refuse bag holder for selective attachment to a cabinet, comprising:
a base support member having a back wall, a pair of side walls connected to said back wall and a front wall connected to said side walls, said back, side, and front walls defining an interior area therebetween;
at least one clamp rotatably coupled to said support member and configured to removably couple said support member to said cabinet;
a closure member having a configuration that is complementary to a configuration of said base support member, said closure member being selectively inserted into said interior area; and
a refuse bag having an open end selectively sandwiched between said base support member and said closure member when said closure member is inserted into said base support member interior area.

2. The refuse bag holder as in claim 1 wherein:
said base support member includes a D-shaped configuration; and
said closure member includes a D-shaped configuration that defines a perimeter slightly smaller that a perimeter of said base support member.

3. The refuse bag holder as in claim 2, wherein said back wall of said base support member includes a linear configuration that is complementary to a front of said countertop.

4. The refuse bag holder as in claim 3, wherein:
said base support member includes an upper edge that is tapered outwardly so as to funnel garbage toward said interior area; and
said closure member includes an upper edge that is complementary to said base support member upper edge so as to nest therein.

5. The refuse bag holder as in claim 4, wherein said refuse bag includes a configuration that is complementary to sad configuration of said base support member.

6. The refuse bag holder as in claim 1, wherein said refuse bag is liquid impermeable.

7. The refuse bag holder as in claim 6, wherein said clamp is movable between a first configuration and at least a second configuration displaced 90 degrees from said first configuration.

8. The refuse bag holder as in claim 1, wherein said clamp is movable between a first configuration and at least a second configuration displaced 90 degrees from said first configuration.

9. The refuse bag holder as in claim 7, wherein said clamp includes a threaded fastener that is selectively loosened in order to move said clamp between said first and second configuration and then tightened to secure said clamp at a desired configuration.
